(19) United States
(12) Patent Application Publication
(10) Pub. No.: US 2026/0167099 A1
(43) Pub. Date: Jun. 18, 2026

(54) MESSAGE AND WARNING DISPLAY SYSTEM FOR A VEHICLE

(71) Applicant: Torc Robotics, Inc., Blacksburg, VA (US)

(72) Inventors: Akshay Pai Raikar, Austin, TX (US); William Gray Davis, Austin, TX (US); Nicholas Atanasov, Austin, TX (US); Pablo Smith, Spicewood, TX (US); Armenio Jose Rivero, Austin, TX (US); Christopher Harrison, Austin, TX (US)

(21) Appl. No.: 18/981,334

(22) Filed: Dec. 13, 2024

(51) Int. Cl. B60Q 1/50; H04W 4/46

(52) U.S. Cl. CPC B60Q 1/5037; H04W 4/46; B60Q 2400/50

(57) ABSTRACT

A message display system for a vehicle is provided. The message display system includes an arrangement of projectors, electronic displays, and/or other visual media devices that are configured to provide messages, warnings, and other information to persons and systems in the proximity of the vehicle. The message display system can be configured to display the messages on the road surface and other surfaces in proximity to the vehicle, as well as on the vehicle itself, for example a body panel of the vehicle or other trailer being hauled by the vehicle. The messages can be controlled autonomously by the vehicle's computing system or manually by a vehicle operator.

### TECHNICAL FIELD

The present disclosure relates generally to a message display system for a vehicle. Specifically, the present disclosure relates to a system of projectors, electronic displays, and/or other visual media devices that display messages, warnings, and other information outside a vehicle for the purpose of providing information to persons and systems in the proximity of the vehicle.

### BACKGROUND

Vehicles utilize a variety of measures to provide information to persons and systems outside of the vehicle. For example, a vehicle may utilize turn signals to indicate to others a lane change or other desired movement of the vehicle. Similarly, a vehicle may utilize flashing lights or a signal horn to warn others about a hazard or emergency condition. In addition, when a vehicle becomes disabled or needs to pull to the side of a roadway, the operator of the vehicle may deploy warning triangles, flares, or similar signaling contraptions in proximity to the vehicle to alert others of the status of the vehicle. However, current signaling systems and methods are limited in the type and amount of information that can be displayed, as well as lacking adaptability to be dynamically updated for changing circumstances. Furthermore, current signaling systems and methods lack robust automation, often requiring input from a person to be operated or deployed.

Accordingly, there exists a need for a messaging and signal display system for a vehicle that is adaptable, automated, and capable of providing messages and other signals with more comprehensive information.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

The present disclosure relates to a message display system for a vehicle in which a system of projectors, electronic displays, and/or other visual media devices are configured to provide messages, warnings, and other information outside the vehicle for the benefit of persons and systems in the proximity of the vehicle.

In accordance with aspects of the present disclosure, a signal system for a vehicle is provided. The signal system for a vehicle includes one or more signal display devices mounted to the vehicle, wherein the signal display devices are configured to display a message that is visible outside of the vehicle, one or more vehicle sensors, and a controller coupled to the signal display devices and a computing system of the vehicle, wherein the controller is configured to receive vehicle status data from the computing system of the vehicle, and control the one or more signal display devices to display the message based on the vehicle status data.

In some aspects, the signal system for a vehicle includes an ambient light sensor, wherein the ambient light sensor is one of the vehicle sensors and is configured to provide environmental condition data to the computing system to adjust one or more message display characteristics of the message.

In some aspects, the signal display devices of the signal system for a vehicle may be attached to an exterior portion of the vehicle or an exterior portion of a trailer attached to the vehicle.

In some aspects, the vehicle status data comprises one or more of vehicle system data, vehicle sensor data, remote operator data, and driver entered data.

In some aspects, the computing system is configured to receive outside vehicle data from one or more outside vehicles. The computing system can transmit the outside vehicle data to the controller so that the outside vehicle data can be used to update the content of the message based on the outside vehicle data.

In some aspects, at least one of the signal display devices is configured to display the message in a message display area.

In some aspects, the message is formed from a plurality of message segments.

In some aspects, the controller is further configured to determine content to be included in the message based on the vehicle status data.

In some aspects, the controller is further configured to determine content for the message based on the vehicle status data.

In accordance with aspects of the present disclosure, a signal system for a vehicle is provided. The signal system for a vehicle includes one or more signal display devices mounted to the vehicle, wherein each of the signal display devices is configured to display a message segment that is visible outside of the vehicle, one or more vehicle sensors, wherein at least one of the vehicle sensors is an ambient light sensor, and a controller coupled to the signal display devices and a computing system of the vehicle, wherein the controller is configured to receive vehicle status data from the computing system of the vehicle, determine content for each of the message segments based on the vehicle status data, control the one or more signal display devices to display each of the message segments, and adjust one or more message display characteristics of each of the message segments based on one or more environmental conditions.

In some aspects, the one or more message display characteristics include brightness intensity, color selection, and message position.

In some aspects, the environmental conditions include lighting conditions, weather conditions, and local topography.

In some aspects, the message segments form a cohesive message.

In some aspects, the vehicle status data includes vehicle sensor data from the one or more vehicle sensors.

In some aspects, the controller is configured to receive message instructions from a remote operator and adjust the message segments based on the message instructions.

In some aspects, at least one of the signal display devices is attached to the vehicle with a mount that enables the signal display device to be repositioned to optimally position the message segment being displayed by the signal display device.

In some aspects, the controller of the signal system is further configured to detect topographical features in the area of the vehicle using the one or more vehicle sensors, determine a message segment display area for each of the message segments based on the topographical features, and control the one or more signal display devices to display the message segments in the message segment display area for each of the message segments.

In accordance with aspects of the present disclosure, a method for displaying a message outside a vehicle using a signal display system. The method involves receiving vehicle status data from a computing system of the vehicle, determining a content for the message based on the vehicle status data, detecting topographical features in an area of the vehicle using one or more vehicle sensors, determining a message display area for the message based on the topographical features, and controlling the signal display device to display the message in the message display area.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a perspective view of a vehicle with a trailer attached thereto;

FIG. 2 is a top view of a vehicle with a trailer attached thereto showing message display areas adjacent to the vehicle and trailer;

FIG. 3 is a side view of a vehicle with a trailer attached thereto showing message display areas adjacent to the vehicle and trailer, as well as on the surface of the trailer;

FIG. 4 is a block diagram of an autonomous vehicle;

FIG. 5 is a block diagram of an example computing system; and

FIG. 6 is an exemplary flow chart illustrating the control of a message and warning display system for a vehicle, in accordance with an embodiment of the present disclosure.

Corresponding reference numbers or characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

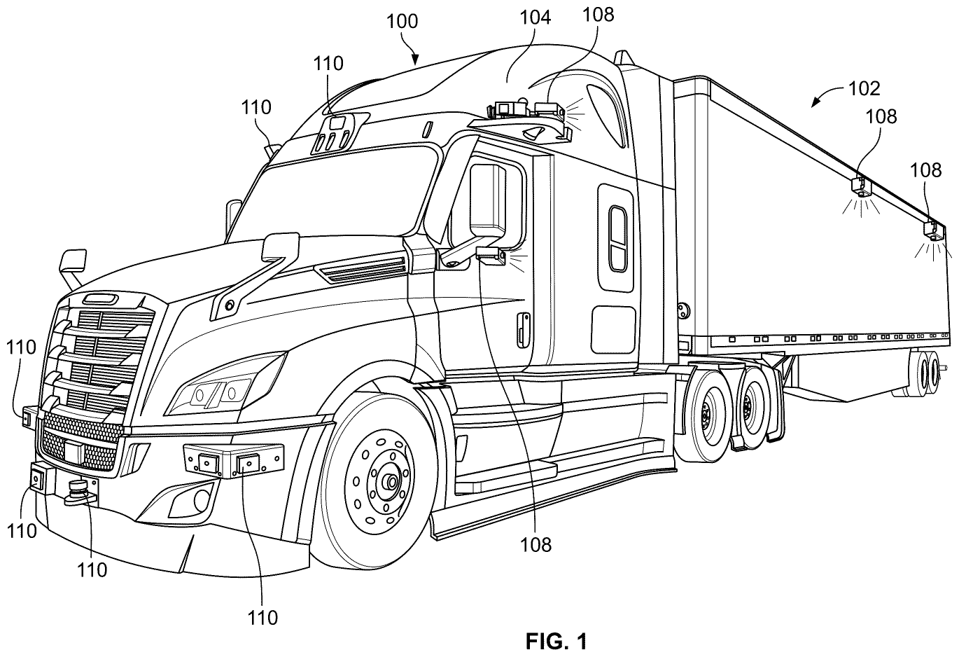

As described herein, a message display system for a vehicle. In various embodiments, the system utilizes one or more projectors, electronic displays, and/or other visual media devices configured to provide messages, warnings, and other information outside the vehicle for the benefit of persons and systems in the proximity of the vehicle. The messages displayed by the system can be used to provide information about the operational status of the vehicle. The messages displayed by the system can also provide information about road and travel conditions in the general vicinity of the vehicle, as well as road and travel conditions farther away from the vehicle. For example, the vehicle could display a message to others vehicles (i) traveling in the same direction about road and travel conditions farther ahead and (ii) traveling in the opposite direction of the vehicle about road and travel conditions such other vehicles may soon encounter. The messages and warnings displayed by the system can help reduce accidents and delays by alerting other vehicles so those other vehicles are better prepared to handle an incident. Various embodiments in the present disclosure are described with reference to FIGS. 1-6 below.

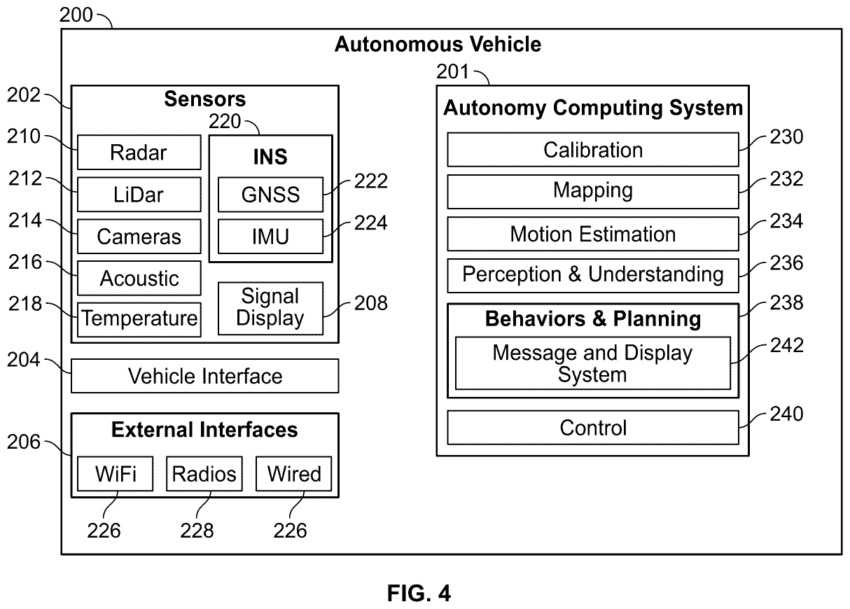

FIG. 1 is a perspective view of a vehicle 100, such as a truck that may be connected to a trailer 102 to transport the trailer 102 to a desired location. The vehicle 100 includes a cabin 104 that can be supported, and steered in the required direction, by front wheels and rear wheels that are shown in FIG. 1. The front wheels are positioned by a steering system that includes a steering wheel and a steering column (not shown). The steering wheel and the steering column may be located in the interior of cabin 104. The vehicle 100 may be an autonomous vehicle (e.g. 200 as shown in FIG. 4), in which case the vehicle 100 may omit the steering wheel and the steering column to steer the vehicle 100. Rather, the vehicle 100 may be operated by an autonomy computing system (e.g. 201 as shown in FIG. 4) of the vehicle 100 based on data collected by a sensor network including one or more sensors, e.g., sensors 110 shown in FIG. 1 or sensors 202 shown in FIG. 4.

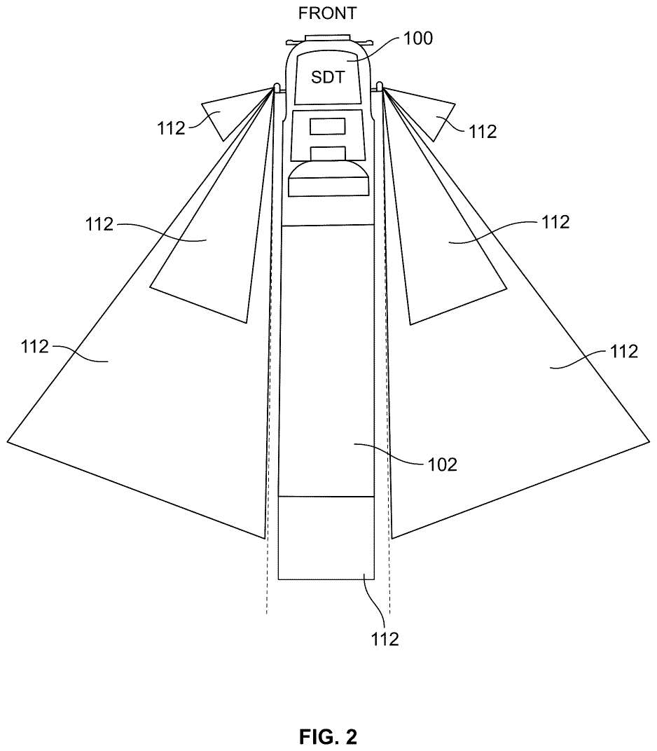

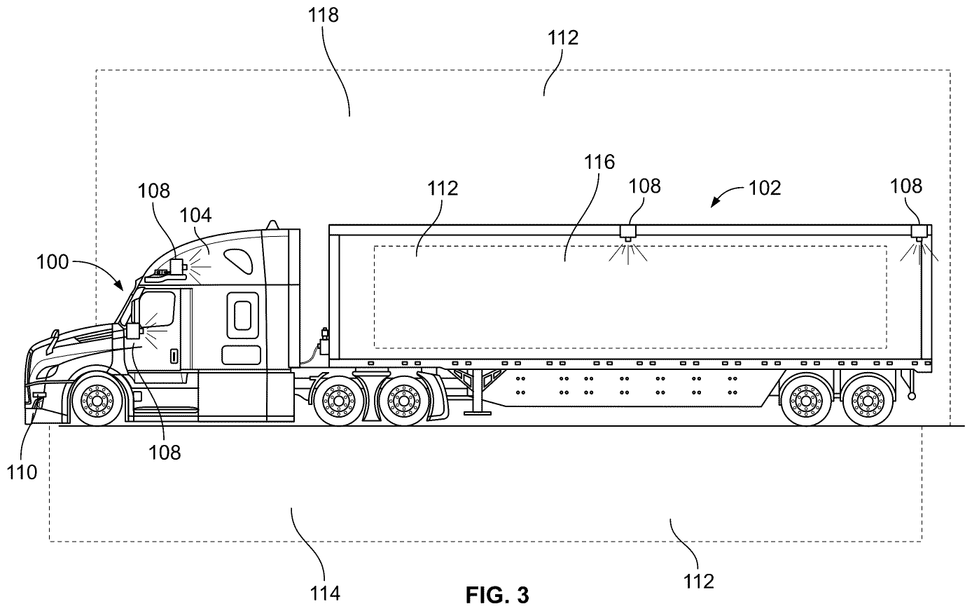

In addition to the sensors 110, the vehicle 100 or trailer 102 is equipped with one or more signal display devices 108 that are configured to display a message, warning, or similar other information. The signal display devices can be attached to any suitable portion of the vehicle 100 or trailer 102 including, but not limited to, the roof cap of the cab 104, side view mirror of the vehicle 100, and walls of the trailer 102. In some embodiments, the signal display devices 108 may be any type of media projectors including, but not limited to, light emitting diode (LED) projectors, liquid crystal display (LCD) projectors, laser projectors, liquid crystal on silicon (LCoS) projectors, digital light processing (DLP) projectors, and short-throw projectors. In some embodiments, the signal display devices 108 may be any type of display screen or panel including, but not limited to, light emitting diode (LED) display panels and liquid crystal display (LCD) display panels. In some embodiments, a signal display device 108 is attached to the vehicle 100 with a mount that enables the signal display device 108 to be repositioned to optimally display a message or message display area (e.g. 112 as shown in FIG. 2 and FIG. 3). One of ordinary skill in the art would appreciate that there are any number of visual media display devices that could be used in the system as a signal display device 108 and embodiments of the present disclosure are contemplated for use with any such visual media display device.

FIG. 2 is a top view of vehicle 100, with a trailer 102, attached thereto showing message display areas 112 adjacent to the vehicle 100 and trailer 102. As shown in FIG. 2, the message display areas 112 can be variably sized and variably positioned in areas around the vehicle 100 or trailer 102. The message display areas 112 are areas where a message, warning, or other information can be displayed by a signal display device 108. In some instances, a message display area 112 may only include a segment of a message (i.e. message segment), in which case such message display area 112 may be a message segment display area. The message display areas 112 can have various sizes and shapes, as well as being dynamically adjustable in terms of size, shape, and position. In particular, media projector type signal display devices 108 are especially adaptable to provide message display areas 112 in a wide array of sizes, shapes, and positions. Additionally, multiple signal display devices 108 may work cooperatively to provide a message, with each of cooperating signal display devices 108 displaying a segment (i.e. a message segment) of the message. For example, a first of the signal display devices 108 could display a first segment of the message in a first of the message display areas 112 and a second of the signal display devices 108 could display a second segment of the message in a second of the message display areas 112. Additionally, message display areas 112 can overlap and/or be configured so that one message display area 112 is displayed within another message display area 112. For example, a first message display area 112 could provide a border within which a second message display area 112 is displayed. In some embodiments, a signal display device 108 corresponds to a particular message display area 112, displaying a message or message segment in that particular message display area 112. As discussed above, the message display areas 112 may be read or understood in a cohesive manner to provide a complete message. In some embodiments, a signal display device 108 may display a message or message segment across multiple message display areas 112. Similar to the above, the message display areas 112 may be read or understood in a cohesive manner to provide a complete message.

For the sake of clarity, this disclosure contemplates a complete message may be formed by combining (i) multiple message segments in a single message display area 112, regardless of whether the message segments are provided by one or multiple signal display devices 108, (ii) multiple message display areas 112, each of those message display areas 112 displaying one message segment, regardless of whether the message segments are provided by one or multiple signal display devices 108, (iii) multiple message segments across multiple message display areas 112, regardless of whether the message segments are provided by one or multiple signal display devices 108, or (iv) any combination thereof. Furthermore, message segments are not necessarily identical to message display areas 112. In particular, whereas message segments are portions of a message, message display areas 112 are areas where a message or message segment can be displayed by a signal display device 108. In addition, by having embodiments with signal display devices 108 that are configured to display one or more message segments in one or more message display areas 112, a highly customizable message display system is provided, allowing for messages or message segments to be advantageously distributed across multiple message display areas 112 using any combination of signal display devices 108.

FIG. 3 is a side view of a vehicle 100 with a trailer 102 attached thereto showing message display areas 112 adjacent to and on the surface of the vehicle 100 and trailer 102. In the example embodiment, the vehicle 100 and trailer 102 are each configured with multiple signal display devices 108. Each of the signal display devices 108 are configured to display a message or message segment in at least one of the message display areas 112 near or on the surface of the vehicle 100 and trailer 102. The message display areas 112 may include, but are not limited to, (i) a message display area 114 on a ground area beside the vehicle 100 and trailer 102, (ii) a message display area 116 on a surface of trailer 102 (i.e. body panel of the trailer 102, but could be a body panel of the vehicle 100), and (iii) a message display area 118 on a surface in proximity to the vehicle, such as (a) a wall of an underpass or tunnel, (b) the surface of a road barrier (e.g. Jersey barrier), (c) a road sign, (d) a wall of a building, or (e) terrain and topographical features (e.g. hill, embankment, etc.). With respect to a message display area 116 on a body panel of the vehicle 100 or trailer 102, a media projector or display panel type signal display device 108 may be used. With respect to message display areas 114, 118 that are on surfaces not on the vehicle 100 or trailer 102, it is preferable to utilize a media projector type signal display device 108.

In example embodiments, messages (or message segments) displayed in message display areas 112 may utilize at least vehicle status data and outside vehicle data to provide content for, or otherwise update, content of the messages (or message segments). The vehicle status data includes, but is not limited to, vehicle system data, vehicle sensor data, remote operator data, and driver entered data. In an example embodiment, vehicle system data includes, but is not limited to, data and information about the vehicle's operating and mechanical status. For example, the vehicle system data may include information about the status of the engine, drivetrain, and brakes, as well as whether any of those systems or components are experiencing a failure or are otherwise in a comprised or limited operating condition. In an example embodiment, the vehicle sensor data includes, but is not limited to, data and information from the vehicle sensors 202 (as further discussed below). In an example embodiment, the remote operator data includes data and information from a remote operator or a remote control system or database. For example, the remote operator data may include commands or other information sent from a remotely located vehicle operator to the vehicle that supplement or override the standard or default operations of the vehicle's computing system. The remote operator data may be especially relevant in the context of an autonomous vehicle. For example, the remote operator data may include manual override commands that take precedence over the autonomous operations of the autonomous vehicle. In an example embodiment, the driver entered data includes data and information from a driver of the vehicle. For example, the driver entered data may include commands or other information entered by a driver of the vehicle that supplement or override the standard or default operations of the vehicle's computing system.

An additional source of data that may be utilized for the content of the message (or message segments) is outside vehicle data. In an example embodiment, outside vehicle data may include data and information from remotely located vehicles and data sources. For example, outside vehicle data may include data and information from a fleet of vehicles (i.e. one or more outside vehicles) that are interconnected via a data network. In the example embodiment, data and information can be transmitted among a fleet of vehicles such that a vehicle in one location can provide road and travel conditions to other vehicles that may be approaching or be routed through that same location. Road and travel condition information may include, but is not limited to, traffic information, weather conditions, and emergency information. Each of the vehicles within the fleet of vehicles may utilize the road and travel condition information to alter its route or display a message in one or more of its message display areas to alert other drivers and vehicles about conditions along the route. In some embodiments, outside vehicle data may include data and information from a database, such as historical traffic and weather patterns. As with the road and travel condition information, a vehicle can share the historical traffic and weather pattern information with other drivers and vehicles via a message in one or more of its message display areas.

In example embodiments, messages (and message segments) are populated with content. In some embodiments, the content of a message may be static. For example, the content of a message may be text-based to provide a warning, alert, or other information. One illustrative example of text-based content is displaying a message such as “Warning: Keep Out” to alert others to stay away from the vehicle due to the vehicle being unsafe or otherwise incapacitated. This could be especially relevant in the context of an autonomous vehicle, where such a warning could indicate that certain of the autonomous vehicle sensors are not working and therefore the autonomous vehicle cannot adequately monitor and react to the actions of people and vehicles in the area of the autonomous vehicle. Other examples of text-based content include providing information about traffic, road, weather, and emergency conditions. Other examples of static content include, but are not limited to, symbols, graphics, and other visual indicators. For example, the content of a message could be color based, with red indicating areas to avoid, yellow indicating areas of caution, and green indicating a safe area. Another example could be indicating a safe path around the vehicle by illuminating a travel lane or displaying a temporary side walk that provide a safe path around the vehicle. Further examples of static symbols could be visualizations of commonly used signaling devices including, but not limited to, emergency triangles, road flares, and caution tape.

In some embodiments, the content of a message may be dynamic or active. For example, the content of a message may video, scrolling text, animated illustrations, or color changing and flashing light areas within a message display area. Utilizing dynamic or active content for a message can provide advantages relative to static content. For example, dynamic or active content in the form of scrolling text enables messages that convey more thorough information. Similarly, utilizing animated illustrations may provide information in a format that is more easily and broadly understood, as illustrations can be used to reduce issues that may be caused by language and literacy barriers. Furthermore, animated illustrations can often provide information in a concise manner that is not possible through a static symbol or longer text-type messages. Another advantage of utilizing dynamic or active content is that messages comprised of dynamic or active content may be more noticeable and better able to capture the attention of others.

In an example embodiment, a signal display device 108 may include or utilize one or more sensors to aid in configuring a message or a message display area 112. Those one or more sensors may be equipped on or with the signal display device 108 itself. Alternatively, the signal display device 108 may cooperate with other sensors of the vehicle. For example, in an autonomous vehicle (e.g. 200 as shown in FIG. 4), the signal display device 108 may utilize the computing system and sensors of the autonomous vehicle (e.g. 201 and 202 as shown in FIG. 4). One type of sensor useful for configuring a message or message display area 112 is an ambient light sensor. The ambient light sensor could be used to regulate one or more message display characteristics including, but not limited to, brightness intensity of the message, color selection, of the message, and message position. For example, the brightness and color of a message and message display area 112 can adjusted by factoring in lighting conditions around the vehicle to optimize the output of the signal display device 108. Additionally, the signal display device 108 can be configured to utilize a variety of optical and measuring sensors to help determine, position, and size the message display area 112. For example, the signal display device 108 may use a camera or LiDAR to help determine an appropriate target area for displaying a message display area 112. The camera or LiDAR could be used to evaluate and locate a suitable surface (e.g. surfaces near the vehicle 100 or trailer 102 including, but not limited to, the ground, body panel of the vehicle 100 or trailer 102, a wall of an underpass, tunnel, road barrier, or building, a road sign, or terrain and topographical features in the area of the vehicle 100) for a message display area 112. The camera or LiDAR could also be used to establish an appropriate size and location for the message display area 112 one the suitable surface, as well as account sight lines (e.g. curves in road, local topography, etc.) that may impact visibility of. Collectively, the ambient light sensor, camera, and LiDAR, can account for any form of environmental condition data including, but not limited to, lighting conditions, weather conditions, and topography. The environmental condition data can be used to adjust the message display characteristics of the message or the message display area. One of ordinary skill in the art would appreciate that there are any number of sensors that might be utilized by the signal display device 108 to configure a message or message display area and embodiments of the present disclosure are contemplated for use with any such sensors.

FIG. 4 is a block diagram of an autonomous vehicle 200. The vehicle 100 shown in FIG. 1 could be configured as an autonomous vehicle 200. In the example embodiment, the autonomous vehicle 200 includes an autonomy computing system 201, sensors 202, a vehicle interface 204, and external interfaces 206.

In the example embodiment, sensors 202 may include various sensors such as, for example, signal display sensors 208, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound, microphones, etc.), internal vehicle sensors, meteorological sensors, or other types of sensors. Sensors 202 generate respective output signals based on detected physical conditions of autonomous vehicle 200 and its proximity. As described in further detail below, these signals may be used by autonomy computing system 201 to determine how to control operations of autonomous vehicle 200.

Cameras 214 are configured to capture images of the environment surrounding autonomous vehicle 200 in any aspect or field of view (FOV). The FOV can have any angle or aspect such that images of the areas ahead of, to the side, behind, above, or below autonomous vehicle 200 may be captured. In some embodiments, the FOV may be limited to particular areas around autonomous vehicle 200 (e.g., forward of autonomous vehicle 200, to the sides of autonomous vehicle 200, etc.) or may surround 360 degrees of autonomous vehicle 200. In some embodiments, autonomous vehicle 200 includes multiple cameras 214, and the images from each of the multiple cameras 214 may be processed to identify objects in the environment surrounding autonomous vehicle 200. In some embodiments, the image data generated by cameras 214 may be sent to autonomy computing system 201 or other aspects of autonomous vehicle 200. For example, the cameras 214 may be used by the signal display device 108 for the purposes of identifying and configuring a message or message display area 112.

LiDAR sensors 212 generally include a laser generator and a detector that send and receive a LiDAR signal such that LiDAR point clouds (or “LiDAR images”) of the areas ahead of, to the side, behind, above, or below autonomous vehicle 200 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination by the signal display device 108 for the purposes of identifying and configuring a message or message display area 112.

GNSS receiver 222 is positioned on autonomous vehicle 200 and may be configured to determine a location of autonomous vehicle 200, which it may embody as GNSS data. GNSS receiver 222 may be configured to receive one or more signals from a global navigation satellite system (e.g., Global Positioning System (GPS) constellation) to localize autonomous vehicle 200 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 200. For example, with two GNSS receivers 222, two attitude angles (e.g., roll and yaw) may be measured or determined. In some embodiments, autonomous vehicle 200 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 200 and its environment.

IMU 224 is a micro-electrical-mechanical (MEMS) device that measures and reports one or more features regarding the motion of autonomous vehicle 200, although other implementations are contemplated, such as mechanical, fiber-optic gyro (FOG), or FOG-on-chip (SiFOG) devices. IMU 224 may measure an acceleration, angular rate, or an orientation of autonomous vehicle 200 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 201 is able to determine the motive characteristics (acceleration, speed/direction, orientation/attitude, etc.) of autonomous vehicle 200.

In the example embodiment, autonomy computing system 201 employs vehicle interface 204 to send commands to the various aspects of autonomous vehicle 200 that actually control the motion of autonomous vehicle 200 (e.g., engine, throttle, steering wheel, brakes, etc.) and to receive input data from one or more sensors 202 (e.g., internal sensors). External interfaces 206 are configured to enable autonomous vehicle 200 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 200 or when downloading mission data after completion of a trip. The connection(s) may be used to download and install various lines of code in the form of digital files (e.g., HD maps), executable programs (e.g., navigation programs), and other computer-readable code that may be used by autonomous vehicle 200 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 200 may deploy with all of the data it needs to complete a mission (e.g., perception, localization, and mission planning) and may not utilize a wireless connection or other connections while underway.

In the example embodiment, autonomy computing system 201 is implemented by one or more processors and memory devices of autonomous vehicle 200. Autonomy computing system 201 includes modules, which may be hardware components (e.g., processors or other circuits) or software components (e.g., computer applications or processes executable by autonomy computing system 201), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a message and display system module 242. The message and display system module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 200.

The message and display system module 242 may perform one or more tasks including, but not limited to, receiving data from the signal display sensor 208 related to the one or more signal display devices 108. For example, the signal display sensor 208 could include an ambient light sensor and one or more sensors. The ambient light sensor could be used to regulate both the brightness and color of a message and message display area 112 by factoring in lighting conditions around the vehicle to optimize the output of the signal display device 108. Additionally, the signal display device 108 can be configured to utilize a variety of sensors (e.g. camera and LiDAR) to help determine, position, and size the message display area 112. The signal display sensor 208 could also be configured to cooperate with other of the sensors 202. The message and display system module 242 can use data from the signal display sensor 208 and other sensors 202, as well as vehicle status data and outside vehicle data, to configure messages (including content of messages) and determine message display areas 112 (e.g. size, location, etc.).

Autonomy computing system 201 of autonomous vehicle 200 may be completely autonomous (fully autonomous) or semi-autonomous. In one example, autonomy computing system 201 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

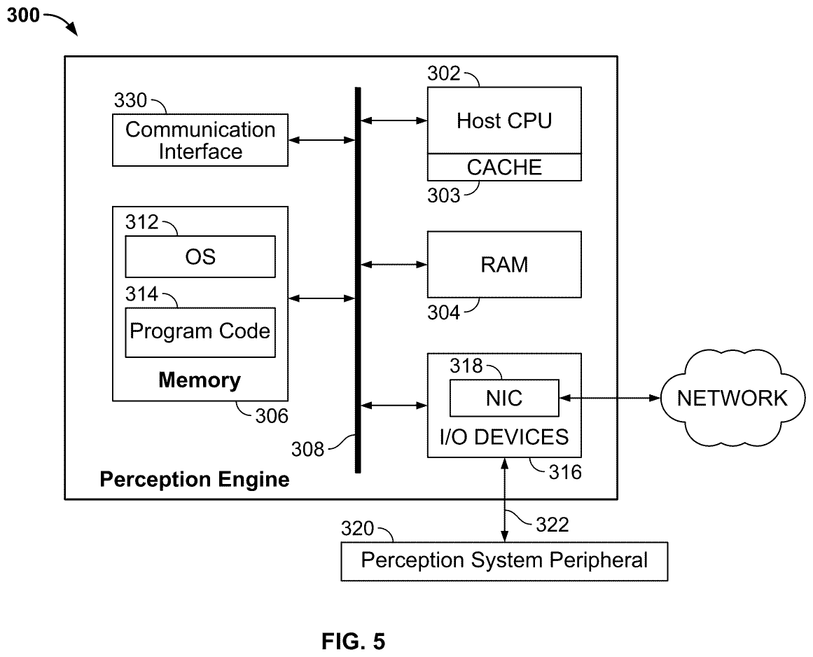

FIG. 5 is a block diagram of an example computing system 300, such as the autonomy computing system 201 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 201 shown in FIG. 4. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

The message and warning display system of the present disclosure may also include operational logic for controlling the message and warning display system for a vehicle. In an example embodiment, the control logic may be stored and executed by the message and display system module 242. In the example embodiment, the message and warning display system for a vehicle may be activated based at least in part on the processing of (i) vehicle status data, (ii) outside vehicle data, or (iii) a combination thereof. In an example embodiment, the message and display system module 242 provides the control logic used to (i) control the one or more signal display devices 108 and (ii) configure messages (including content of messages) and message display areas 112 (e.g. size, location, etc.). The message and display system module 242 can control each of the one or more signal display devices 108 individually, thereby enabling the each of the one or more signal display devices 108 to operate independently (e.g. each providing a separate message) or in unison (e.g. each providing a message segment of the message). The message and display system module 242 may operate with or independently of the controller 240. Each of the controller 240 and the message and display system module 242 may can be configured to cooperate with or control the one or more signal display devices 108 and the signal display sensor 208, as well as configure messages (including content of messages) and determine message display areas 112 (e.g. size, location, etc.).

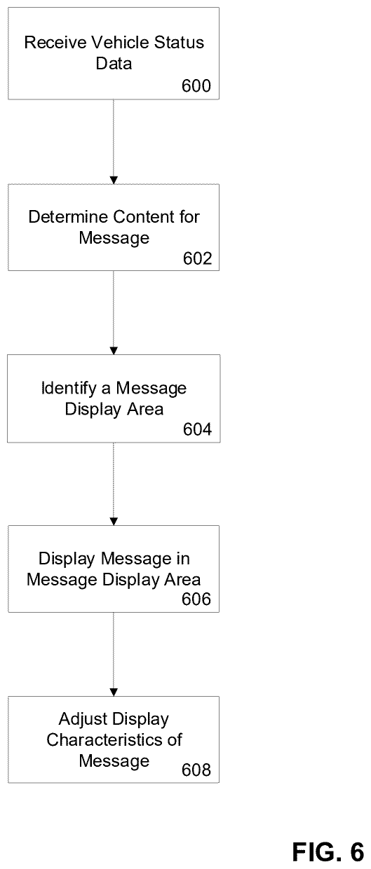

FIG. 6 is an exemplary method flow illustrating the control of a message and warning display system for a vehicle. In an example embodiment, at 600, the control 240 and/or message and display system module 242 receive vehicle status data from the autonomous vehicle 200. At 602, the control 240 and/or message and display system module 242 determines a content for the message. The determination at 602 is based, at least in part, on vehicle status data, but may also be based on outside vehicle data. At 604, the control 240 and/or message and display system module 242, along with the signal display sensors 208 and/or other sensors 202, cooperate to identify a message display area. At 606, the control 240 and/or message and display system module 242 control the signal display device 108 to display the message in the message display area. At 608, the control 240 and/or message and display system module 242, along with the signal display sensors 208, cooperate to adjust the message display characteristics of the message based, at least in part, on environmental condition data.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, and algorithms, described above may be implemented as electronic hardware, software, or combinations of both. Certain disclosed components, blocks, modules, circuits are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element recited in the singular and proceeded with the word “a” or “an” should be understood as not excluding plural elements unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A signal system for a vehicle, comprising:
one or more signal display devices mounted to the vehicle, wherein the signal display devices are configured to display a message that is visible outside of the vehicle;
one or more vehicle sensors; and
a controller coupled to the signal display devices and a computing system of the vehicle, wherein the controller is configured to:
receive vehicle status data from the computing system of the vehicle, and
control the one or more signal display devices to display the message based on the vehicle status data.

2. The signal system of claim 1, further comprising an ambient light sensor, wherein the ambient light sensor is one of the vehicle sensors and is configured to provide environmental condition data to the computing system to adjust one or more message display characteristics of the message.

3. The signal system of claim 1, wherein at least one of the signal display devices is attached to an exterior portion of the vehicle.

4. The signal system of claim 1, wherein at least one of the signal display devices is attached to an exterior portion of a trailer that is attached to the vehicle.

5. The signal system of claim 1, wherein the vehicle status data comprises one or more of vehicle system data, vehicle sensor data, remote operator data, and driver entered data.

6. The signal system of claim 1, wherein the computing system is configured to receive outside vehicle data from one or more outside vehicles.

7. The signal system of claim 6, wherein the computing system transmits the outside vehicle data to the controller and the controller is configured to update a content of the message based on the outside vehicle data.

8. The signal system of claim 1, wherein at least one of the signal display devices is configured to display the message in a message display area.

9. The signal system of claim 1, wherein the message is formed from a plurality of message segments.

10. The signal system of claim 1, wherein the controller is further configured to determine a content for the message based on the vehicle status data.

11. The signal system of claim 1, wherein the controller is further configured to determine a message display area in which to display the message.

12. A signal system for a vehicle, comprising:
one or more signal display devices mounted to the vehicle, wherein each of the signal display devices is configured to display a message segment that is visible outside of the vehicle;
one or more vehicle sensors, wherein at least one of the vehicle sensors is an ambient light sensor; and
a controller coupled to the signal display devices and a computing system of the vehicle, wherein the controller is configured to:
receive vehicle status data from the computing system of the vehicle,
determine a content for each of the message segments based on the vehicle status data,
control the one or more signal display devices to display each of the message segments, and
adjust one or more message display characteristics of each of the message segments based on one or more environmental conditions.

13. The signal system of claim 12, wherein the one or more message display characteristics include brightness intensity, color selection, and message position.

14. The signal system of claim 12, wherein the environmental conditions include lighting conditions, weather conditions, and local topography.

15. The signal system of claim 12, wherein the message segments form a cohesive message.

16. The signal system of claim 12, wherein the vehicle status data includes vehicle sensor data from the one or more vehicle sensors.

17. The signal system of claim 12, wherein the controller is configured to receive message instructions from a remote operator and adjust the message segments based on the message instructions.

18. The signal system of claim 12, wherein at least one of the signal display devices is attached to the vehicle with a mount that enables the at least one signal display device to be repositioned to optimally position the message segment being displayed by the at least one signal display device.

19. The signal system of claim 12, wherein the controller is further configured to:
detect topographical features in the area of the vehicle using the one or more vehicle sensors;
determine a message segment display area for each of the message segments based on the topographical features; and
control the one or more signal display devices to display the message segments in the message segment display area for each of the message segments.

20. A method for displaying a message outside a vehicle using a signal display system, comprising:
receiving vehicle status data from a computing system of the vehicle;
determining a content for the message based on the vehicle status data;
detecting topographical features in an area of the vehicle using one or more vehicle sensors;
determining a message display area for the message based on the topographical features; and
controlling the signal display device to display the message in the message display area.
